(19) United States
(12) Patent Application Publication
(10) Pub. No.: US 2010/0252573 A1
(43) Pub. Date: Oct. 7, 2010

(54) PERFUME BOTTLE

(76) Inventors: Christoph Hetmaniok, Hoxter (DE); Arturetto Landi, Hoxter (DE)

Correspondence Address: MYERS WOLIN, LLC, 100 HEADQUARTERS PLAZA, North Tower, 6th Floor, MORRISTOWN, NJ, 07960-6834, US

(21) Appl. No.: 12/817,475

(22) Filed: Jun. 17, 2010

Related U.S. Application Data
(63) Continuation of application No. PCT/EP2008/003018, filed on Apr. 16, 2008.

(30) Foreign Application Priority Data
Dec. 19, 2007 (DE) 20 2007 017 863.8
Feb. 28, 2008 (DE) 20 2008 002 856.6

(51) Int. Cl. B65D 35/56; B67D 7/06; G01F 11/00

(52) U.S. Cl. 222/105; 222/183; 222/325

(57) ABSTRACT

A perfume bottle (1) has a liquid-tight inner casing (3) which is filled with a perfume and is provided with an outlet (4), and a dimensionally stable housing (2) designed in a manner suitable for exchangeably accommodating the inner casing (3). The perfume bottle (1) also has an actuating device (7) which interacts with the outlet (4) of the inner casing (3) in order to dispense the perfume.

This application is a continuation of International Application PCT/EP2008/003018, filed on Apr. 16, 2008, which claims priority to DE 20 2008 002 856.6, filed on Feb. 28, 2008 and DE 20 2007 017 863.8, filed on Dec. 19, 2007, the contents of each being incorporated herein by reference.

The present invention relates to a perfume bottle.

Perfume bottles are known in the most varied embodiments from the prior art and are mostly made essentially from glass. In the prior art either a spout in the manner of a bottle neck which can be closed or exposed by a cover which is able to be placed or screwed thereon, or a liquid duct which is able to be actuated by a spray head and extends into the bottle, with the perfume situated in the bottle being able to be delivered in a dosed manner by a pumping movement on the spray head, serve as an outlet for the delivery of the perfume situated in the bottle.

For each specific perfume, its own bottle is produced, which on the one hand proves to be expensive due to the frequently high-class production of perfume bottles, and on the other hand also runs counter to aspects of environmental protection. Such a bottle which by its external design is mostly to be associated with the respective perfume is usually disposed of after its contents have been used up. A refilling with the same or a different perfume of the same manufacturer is not provided within the scope of usual channels of distribution.

In addition, refillable bottles are also known from the prior art which, with an outer design which is kept neutral, give no indication of the type of perfume contained therein and into which a certain quantity of perfume can be filled. Here, also, initially the purchase of a perfume distributed in a separate bottle is required. In addition, when a change of the type of perfume is aimed for, the refillable bottle must firstly be emptied into a container which is to be provided separately and then washed extremely thoroughly, so as not to cause a contamination of the newly filled perfume with a residual quantity of the perfume previously situated in the bottle which may possibly still be present in the bottle. When the bottle is filled with a different scent, it would no longer be detectable which perfume is now in the bottle.

Proceeding from this, the object of the present invention is to provide a perfume bottle which is able to be used several times, is aesthetically attractive and original, by which the above-mentioned disadvantages can be avoided and which—even with a different perfume—can be re-used in as simple and favourably priced a way as possible.

The perfume bottle which is the subject of the invention comprises here an inner casing which is filled with perfume, is fluid-tight and is equipped with an outlet for the perfume, and an inherently stable housing which is suitably designed to exchangeably receive the inner casing, with the perfume bottle having an actuating device—for the delivery of the perfume—which cooperates with the outlet of the inner casing.

Consequently within the framework of the present invention, a perfume bottle is provided, having an exchangeable inner casing, the inherently stable housing of which can be produced in a high quality and, in so doing, is re-usable. To do this, the (outer) housing of the perfume bottle according to the invention is designed in such a way that on the one hand it is made possible to exchange the inner casing containing the perfume and that on the other hand the outlet—arranged on the inner casing—for the perfume or an actuating device cooperating therewith is able to be actuated for the delivery of the perfume. To do this, the housing of a perfume bottle according to the invention can preferably have a through-opening for an outer part of the outlet of the inner casing, so that the actuating device, cooperating with the outlet for the delivery of the perfume, can be arranged outside the housing and therefore is freely accessible for its actuation. In so far as the type of actuating device requires this, the housing may if applicable also have removable means for covering the actuating device, so that an inadvertent delivery of perfume, e.g. during transportation of the bottle, is avoided.

It proves to be particularly advantageous within the framework of the present invention when the inner casing is formed so as to be transparent. This is not only advantageous in connection with the viewing windows in the housing which are described further below, but also can substantially make it easier or even possible to take a bottle according to the invention on an aeroplane journey. The extremely strict safety regulations which are in force in airports only allow liquids such as perfume to be carried when these are transported in a transparent casing. Thus, in the case of a perfume bottle according to the invention, the transparent inner casing—even in the case of an opaque housing—can be taken out of the housing, whereby the current safety regulations in air traffic, which may perhaps be further intensified in future, can be complied with.

In addition, it is to be established that with the present invention, a standard, as it were, can be created for inner casings which are suitable for holding in the housing of a perfume bottle according to the invention, so that for a particular sort of inner casings, various (bottle) housings can be offered, which meets the increasing wishes of the consumers for individuality in a product.

In connection with the present invention, it is noted that for example in the field of fixedly mounted soap- and disinfectant dispensers, the use of exchangeable re-fill cartridges is already known. Perfume bottles, on the other hand, are subject to a different requirement profile in particular also with regard to their purpose of use, which must also for example allow the perfume bottle to be carried in a handbag. The term “perfume” is to be understood within the framework of the present invention to mean any liquid (with or without an ethanol component) which is provided for perfuming the skin, in which in particular in the case of the embodiment of the invention described further below, in which a spray head acting as an atomizer for the perfume is provided as an actuating device, the focus is to be that the perfume has a consistency which is suited to atomization, i.e. is able to be sprayed. This may be a perfume here in any desired concentrations of the synthetic or natural components determining the fragrance which are usually used for this, such as for example perfume extract, EDP, EDT, cologne, after-shave lotion or suchlike, to which for example water, emulsifiers or silicone can also be added.

In a first preferred development of the invention, provision is made that the inner case is constructed in the form of a foil container equipped with the outlet—and preferably transparent.

This not only has the advantage of a particularly favourably priced production of the inner casing, to be discarded after having been completely emptied, compared with previously known perfume bottles, but also proves to be advantageous in that the empty inner casing can be folded up to a reduced volume which facilitates its disposal. In addition, a foil container has a lower weight, which also proves to be favourable with regard to its transportation. Furthermore, the construction of the outlet on the inner casing proves to be particularly advantageous with regard to as simple an exchange of the inner casing as possible. This is because an inner casing which is possibly filled with a different perfume and is to be used again does not have to be connected in a complicated manner so as to be fluid-tight with an outlet constructed on the inherently stable housing, but rather can be inserted into the housing in a simple manner together with the outlet after the previously used inner casing has been removed together with its outlet. Here, in the case of different types of perfumes moreover no contamination occurs either of a new perfume with residues of the previously used perfume. In particular, a plastic foil, e.g. of PET or PVC comes into consideration here as the material for the inner casing designed foil container, in which with regard to the material which is to be chosen and the actual design of the inner casing it is to be taken into consideration that perfume generally also has highly volatile contents.

Suitable foil containers are already known from the prior art. For this, reference is to be made for example to EP 0 493 723 B1, EP 0 442 659 B1 or U.S. Pat. No. 4,732,299.

In addition, in a further preferred development of the invention, it proves to be advantageous when the foil container consists of two foil layers which are connected with the outlet in a fluid-tight manner in the region of the outlet and in addition are thermally connected with each other on the edge side, forming in their immediate connection region an edge which cooperates with corresponding fastening means of the housing for fastening the inner casing in fixed position on or in the housing.

The outlet, or a base body of the outlet provided for this, which is connected with the inner casing, preferably consists here of an inherently stable plastic, having a through-opening, with the foil layers which border the outlet on both sides in a fluid-tight manner preferably being fused thermally for this with the outlet. The edge which is likewise preferably formed by thermal fusing of the two foil layers can serve to some extent as a flange for fastening the inner casing on or in the housing.

Here, the edge is preferably to have a sufficient width, e.g. be more than 3, 4 or 5 mm wide, so that pins formed on the housing of the perfume bottle and serving as fastening means can cooperate with corresponding holes in the edge of the inner casing to fasten the inner casing on the housing so as to be fixed in position without, in so doing, the tightness of the inner casing being endangered. Corresponding holes, which respectively cooperate with a pin of comparable diameter formed on the housing, can already be introduced in the edge of the inner casing. The pins provided on the housing are to be as blunt as possible, so that on insertion of the inner casing, filled with perfume, into the housing, there is no risk of the inner case being damaged.

Within the framework of the invention, guide tracks or clamping means facing each other also come into consideration as fastening means on the housing side, which then preferably receive, fixed in position, edge regions of the inner casing which lie opposite each other. In this case, also, advantageously a suitable width is to be provided of the edge of the inner casing held by the clamping device and/or the guide track, which is preferably to be above the already mentioned minimum values.

The outlet of the perfume bottle according to the invention, which is arranged on the inner casing, can preferably have a base body connected with the inner casing and a liquid duct extending into the inner casing, through which duct the perfume is delivered by means of a spray head, acting as an actuating device, of a pump dosing arrangement. The spray head can be constructed here either as part of the inner casing which is to be exchanged or as part of the housing, preferably of high quality construction, of a perfume bottle according to the invention, which also allows it to be re-used.

On the other hand, in a somewhat simpler construction of a perfume bottle according to the invention, the outlet can also have an outlet opening for the perfume in the manner of a bottle neck, which is able to be exposed and closed again by means of a cover acting as an actuating device and able to be screwed or placed on.

In a further preferred development of the invention, for the purpose of simple exchangeability of the inner casing, provision is made that the housing consists of two housing parts which can assume a closed position holding the inner casing and an open position suitable for exchanging the inner casing.

Here, the two housing parts can be advantageously connected via a hinge-like structure, by which they can be swivelled from their closed position into the open position. However, if, for aesthetic reasons, one wishes to dispense with a hinge structure, the two housing parts can also be constructed so that they are completely separable for the purpose of exchanging the inner casing.

The inner casing is preferably held between the two housing parts, in which an outlet formed on the inner casing and also preferably so as to be inherently stable in the case of a flexible inner casing, can be held in a form-fitting manner in corresponding recesses of the two housing parts or housing halves, which improves the fastening, in fixed position, of the entire inner casing—connected in a fluid-tight manner with the spout—on the housing of a perfume bottle according to the invention.

In the case of its development having several parts, the housing preferably has a detent—or screw mechanism by which the two housing parts are able to be engaged or screwed to each other in their closed position. Such a detent mechanism is to be clearly detachable again, in order to make possible a simple exchange of one inner casing by another inner casing.

In addition, in a further preferred development of the invention, provision is made that the housing has a framelike structure with at least one viewing opening onto the inner casing. This viewing opening preferably serves several purposes simultaneously. In the case of an—at least in this region—inner casing which is constructed so as to be transparent or translucent, it is possible for the user of the perfume bottle according to the invention to monitor the filling level of the inner casing with perfume. In addition, the inner casing can preferably also have lettering in this region, which contains for example an indication of the perfume inside the inner casing, or its manufacturer. Finally, if applicable by special colouring, design or choice of material, an indication can also be given of the actual perfume in the inner casing. Corresponding viewing windows which can either be in the form of a transparent material of the housing or as an opening thereof, also prove to be extremely decorative in connection with suitably designed inner casings; here, however, also in the interests of the overall aesthetic impression, preferably a fixed fastening of the inner casing inside the housing is to be provided. Means which are suitable for this have already been mentioned.

However, within the framework of the present invention, provision can likewise be made that the housing is completely closed in its position holding the inner casing, so that the inner casing is not detectable from the exterior, which proves to be expedient—especially in the case of a housing which is of particularly high quality design.

The housing of a perfume bottle according to the invention, which is constructed so as to be substantially inherently stable, can consist of the most varied of materials. In addition to glass or precious metals such as silver or gold, plastic or light metals such as aluminium also come into consideration. Also, a combination of several materials within a housing is possible.

Finally, the present invention comprises not only an individual perfume bottle according to the invention of a housing and an inner casing filled with perfume, but rather also a set of a perfume bottle according to the invention and at least one further inner casing filled with the same or a different perfume and/or at least one further housing for the at least one inner casing. It is obvious that also the at least one further inner casing must be suitably designed to be received into the housing or that the at least one further housing, as also the housing of the perfume bottle according to the invention, must be suitably designed to receive all the inner casings belonging to the set, in which, however, in particular its outer design, lettering and/or colouring or else the material can be different from the corresponding characteristic of one of the other inner casings or of another housing of the set. A different design of the inner casings is suitable or even necessary in particular when two inner casings of the set, which are able to be inserted as intended in like manner into the housing of the perfume bottle according to the invention, are different by their being filled with a different perfume.

The invention is described in further detail below with the aid of the drawings, in which:

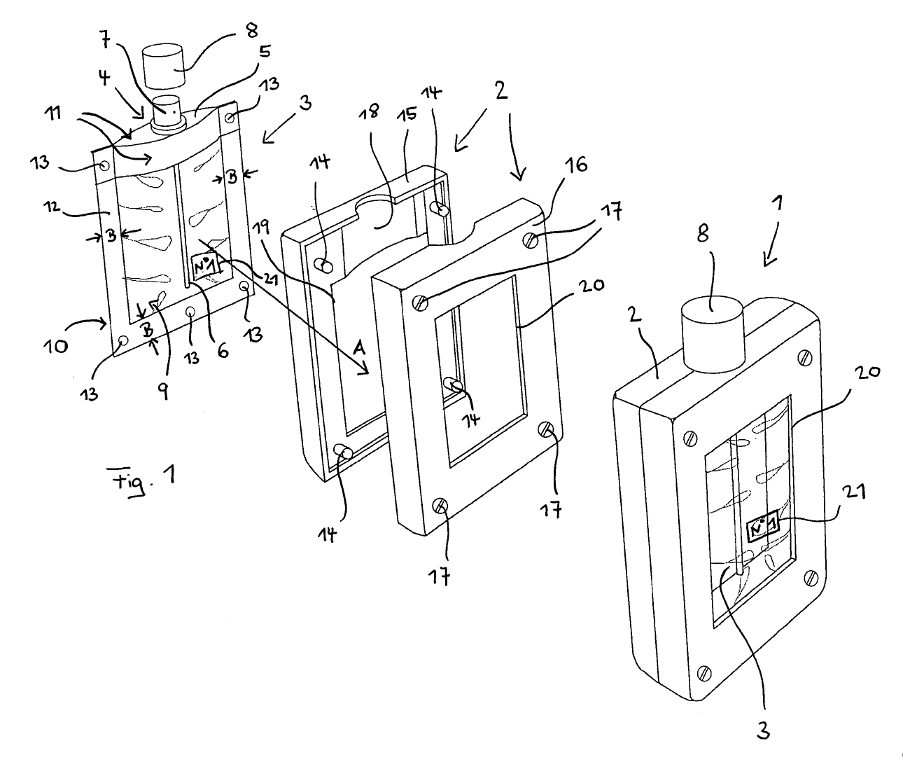

FIG. 1 shows a first example embodiment of a perfume bottle according to the invention,

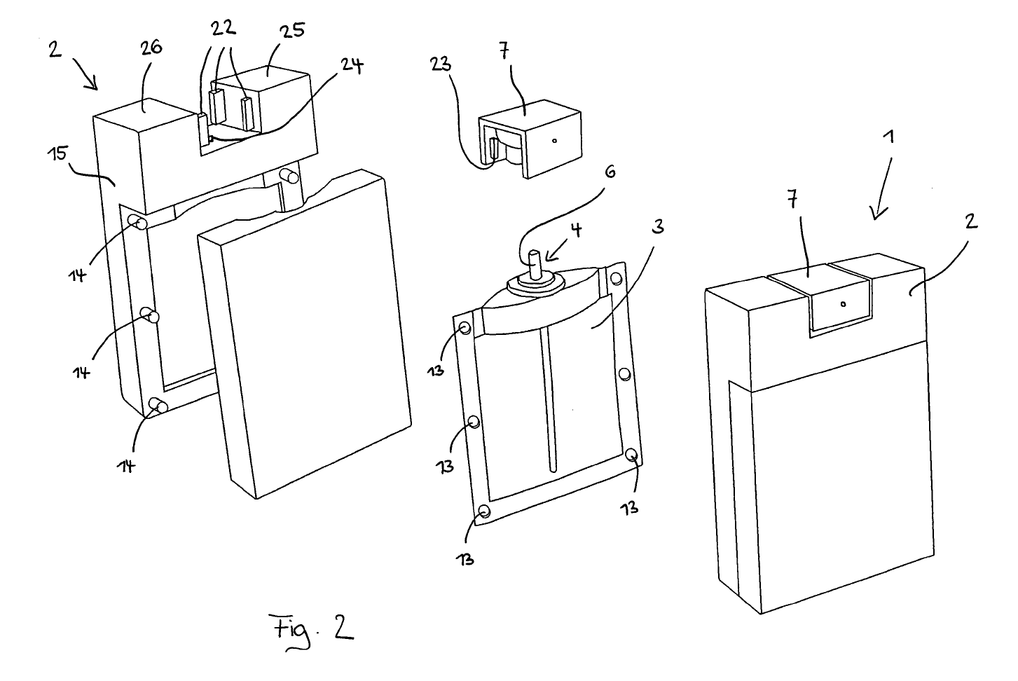

FIG. 2 shows a second example embodiment of a perfume bottle according to the invention,

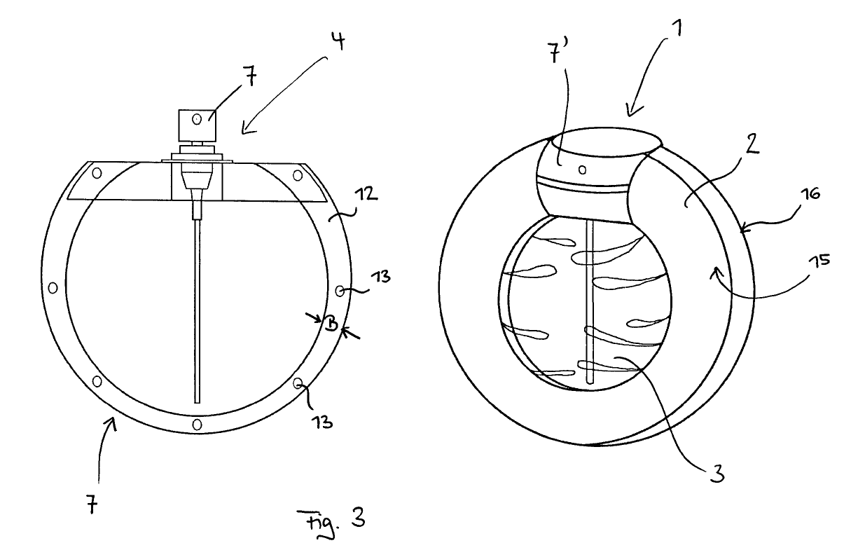

FIG. 3 shows a third example embodiment of a perfume bottle according to the invention, and

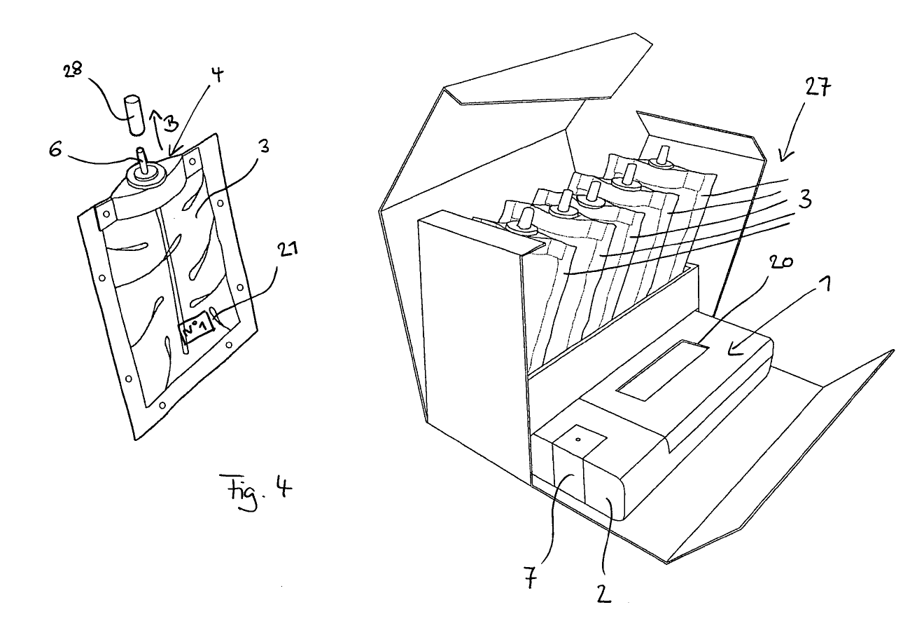

FIG. 4 shows an example embodiment of a set, according to the invention, of perfume bottle and several exchangeable inner casings.

The example embodiment of a perfume bottle 1 according to the invention, illustrated on the right in FIG. 1, consists of a housing 2, illustrated again separately in the middle of FIG. 1, and a transparent inner casing 3, illustrated in full on the left in FIG. 1, with an outlet 4. The outlet 4 of the inner casing 3, filled with perfume, is constructed in the form of a liquid duct 6 guided through a base body 5, which duct 6 extends from the outer side of the inner casing 3 to deep into the inner casing 3 and is securely connected with the base body 5 of the outlet 4. A commercial spray head 7 is placed onto the outer end of the liquid duct 6, which spray head serves in the sense of a pump dosing arrangement as an actuating device for the delivery of the perfume which is situated in the inner casing 3. The spray head 7 can finally be additionally closed by a cover 8, in order to prevent an unintentional actuation of the spray head 7, cooperating with the outlet 4 as an actuating device. It is obvious that the cover 8 can also have a different shape from the illustration in FIG. 1, in so far as it fulfils its intended purpose.

The inner casing 3 is formed from plastic foil as a substantially flexible foil container, in which the two foil layers 9, 10 forming the front and rear sides of the illustrated inner casing 3 are connected in a fluid-tight manner in the region 11 of the base body, constructed so as to be inherently stable, of the outlet 4 respectively (from different sides) therewith. Furthermore, the two foil layers are thermally fused to each other in their edge regions, lying immediately adjacent to each other, forming an edge 12 with width B. The fluid-tight connection of the two foil layers 9, 10 on both sides with the outlet 4—also consisting of plastic—likewise takes place by thermal fusing.

Inside the edge 12, in which the two foil layers 9, 10 are thermally fused over the entire surface, several holes 13 are formed, which—with inner casing 3 held inside the housing 2—are penetrated by pins 14, arranged accordingly on the housing 2, to fasten the inner casing 3 securely in position inside the housing 2.

The multiple-part housing 2, illustrated in the middle of FIG. 1 in its open position suitable for the exchanging of the inner casing 3, consists of two inherently stable housing halves 15, 16, which are respectively formed as a framelike structure and which—after insertion of the exchangeable inner casing 3 filled with perfume according to arrow A—are screwed to each other by means of several screws 17, after which the housing 2 of the bottle 1 is situated in the closed position illustrated on the right. For the purpose of screwing, the pins 14 arranged opposite the screws 17 on the one housing half 15 have an internal thread (not visible in FIG. 1), into which the screws 17 penetrating the other housing half 16 are screwed. The outlet 4, situated on the inner casing 3 and bordered laterally by the foil layers 9, 10, is received in a correspondingly constructed mounting 18 in the two housing halves 15, 16 and is held there in a form-fitting manner.

Each housing half 15, 16 has a viewing window 19, 20, which on the one hand can serve for monitoring the filling level of the inner casing 3 with perfume and on the other hand exposes the view onto lettering 21 of the inner casing 3 arranged in this region.

After the perfume situated in the inner casing 3 has been used up—or if, for other reasons, an exchange of the inner casing 3 is desired—the inner casing 3 can be removed from the housing 2 again after loosening the screw coupling and exchanged for an inner casing 3—if applicable filled with a different perfume—of identical type of construction but of if applicable a different design. The inner casing 3 removed from the housing 2 can, however, also be inserted into a housing of a different type—not illustrated—, with which it then forms again a bottle according to the invention—differing in its outer design from that of FIG. 1.

FIG. 2 shows a second example embodiment of a perfume bottle 1 according to the invention of a multiple-part and re-usable housing 2 and of an inner casing 3 equipped with outlet 4. To avoid repetitions, components of the perfume bottle 1 which correspond to each other functionally are described with the same reference numbers as in FIG. 1.

In the perfume bottle of FIG. 2—as can be seen in the left-hand illustration—the housing 2 is also constructed from two inherently stable housing parts 15, 16, between which a suitably designed inner casing 3 can be inserted so as to be exchangeable. The inner casing 3 of the example embodiment illustrated in FIG. 2 is identical in construction to that of FIG. 1, so that further comments on this are superfluous. It is merely to be established that the spray head 7, acting as actuating device for the outlet 4, is to be regarded this time, due to its type of construction, as a component of the housing 2, on the upper side of which it is also arranged. The spray head 7—after insertion of the inner casing 3 into the two-part housing 2—is placed onto the end of the liquid duct 6 of the spout 4 extending through a through-opening 24 out from the housing 2, and is guided there by means of the guiding means 22, 23 linearly between two shoulders 25, 26, laterally surrounding the spray head 7, of a housing part 15.

The pins 14, again penetrating through corresponding holes 13 in the edge of the inner casing 3 and formed on a housing part 15 are shaped slightly conically here and—differently from in the example embodiment of FIG. 1—have no internal thread. Rather, for the production of a connection, in the manner of a press fit, of the two housing parts 15, 16, they are inserted into suitably constructed recesses in the opposite housing part 16 which, however, can not be seen in FIG. 2 for perspective reasons. In addition, if applicable a detent mechanism, which is not illustrated, can serve for fixing the two housing parts 15, 16 in their closed position illustrated on the right in FIG. 2, in which furthermore there is no view onto the inner casing 3 situated inside the housing 2.

FIG. 3 shows on the right-hand side a third example embodiment of a perfume bottle 1 according to the invention, in which an inner casing 3 filled with perfume, said casing being illustrated again separately on the left in FIG. 3, is arranged exchangeably in a housing 2 suitably designed for this, in which the spout 4 arranged on the inner casing 3 is able to be actuated by means of a spray head 7, held by a housing element 7′, to deliver the perfume. The essential difference from the example embodiments already previously explained consists in that the cross-section of inner casing 3 and housing 2 is round—and not rectangular as previously. Here, also, the housing 2 is designed in two parts from two housing parts 15 and 16 which are framelike and—which, however, can not be seen from the figure—are able to be engaged with each other, the inner casing 3, designed as a foil container in the manner already explained above, being fastened so as to be fixed in position again by means of pins (not illustrated) formed on the housing parts, which engage through holes 13 correspondingly formed in an edge 12 of the inner casing 3.

FIG. 4, finally, shows a set 27 according to the invention of a bottle 1 according to the invention and several inner casings 3—filled with various perfumes—in which the perfume bottle 1 which is illustrated here differs from that of FIG. 2 merely by a viewing window 20 in the housing 2 of the perfume bottle 1—not present in the bottle of FIG. 2. The individual inner casings 3 are provided with letterings 21 which differ from each other, which characterize the type of perfume contained respectively and which—with the insertion of the respective inner casing 3 into the housing 2—respectively lie in the region of the viewing window 20. In addition, with each inner casing 3, the exterior of the end of the liquid duct 6 which is to be associated with the spout 4 is closed by a cover 28 which is put in place, which can be removed from the liquid duct 6 again in accordance with arrow B.

We claim:

1. A perfume bottle (1) comprising a fluid-tight inner casing (3) filled with a perfume and equipped with an outlet (4), and also a housing (2) which is inherently stable and is suitably designed to exchangeably receive the inner casing (3), in which the perfume bottle (1) has an actuating device (7) cooperating with the outlet (4) of the inner casing (3) to deliver the perfume,
wherein the inner casing (3) is designed in the form of a foil container equipped with an outlet (4) and
wherein the foil container includes two foil layers (9, 10) connected with the outlet (4) in a fluid-tight manner in the region of the outlet (4) and otherwise thermally connected with each other on the edge side, which layers (9, 10) form in their connecting region an edge (12) which cooperates with corresponding fastening means (14) of the housing (2) for fastening the inner casing (3) on the housing (2) so as to be fixed in position.

2. The perfume bottle (1) according to claim 1, wherein the outlet (4) has a liquid duct (6) extending into the inner casing (3), through which duct (6) the perfume is delivered by means of a spray head (7), acting as an actuating device, of a pump dosing arrangement.

3. The perfume bottle (1) according to claim 1, wherein the outlet (4) has a bottleneck-like outlet opening that is capable of being exposed and of being closed again by a cover which is capable of being screwed on or placed on, acting as an actuating device.

4. The perfume bottle (1) according to claim 1, wherein the housing (2) comprises two housing parts (15, 16) which can assume a closed position holding the inner casing (3) and an open position suitable for exchanging the inner casing (3).

5. The perfume bottle (1) according to claim 4, wherein the two housing parts (15, 16) are connected by a hinge, by which the housing parts can be swivelled from their closed position into the open position.

6. The perfume bottle (1) according to claim 4, wherein the housing (2) has a detent mechanism by which the two housing parts are able to be engaged with each other in their closed position.

7. The perfume bottle (1) according to claim 1, wherein the housing (2) has a framelike structure with at least one viewing opening (19, 20) onto the inner casing (3).

8. The perfume bottle (1) according to claim 7, wherein the inner casing (3) held by the housing (2) has lettering (21) in the region of the viewing opening (19, 20).

9. The perfume bottle (1) according to claim 1, wherein the housing (2) is completely closed in its position holding the inner casing (3), so that the inner casing (3) cannot be detected from the exterior.

10. A perfume set comprising at least one perfume bottle (1) according to claim 1 and at least one additional inner casing (3) filled with the same or a different perfume.

11. The perfume set according to claim 10, further comprising a plurality of inner casing (3), at least two of the plurality of inner casings (3) differing from each other by their being filled with a different perfume and by having a different lettering (21) and/or colouring.

12. A perfume bottle (1) comprising a housing (2) and a fluid-tight inner casing for containing perfume and having an outlet (4), the housing (2) being inherently stable and suitably designed to exchangeably receive the inner casing (3), an actuating device (7) cooperating with the outlet (4) of the inner casing (3) to deliver perfume contained within the inner casing, wherein the inner casing (3) is a foil container having two thermally-connected foil layers (9, 10) connected with the outlet (4) in a fluid-tight manner in the region of the outlet (4), which layers (9, 10) form in their connecting region an edge (12) which cooperates with corresponding fastening means (14) of the housing (2) for fastening the inner casing (3) on the housing (2) so as to be fixed in position.

13. The perfume bottle (1) according to claim 12, wherein the edge (12) further comprises openings (13) and wherein the fastening means (14) further comprise pins on the housing (2) that extend through the openings (13) for retaining the inner casing (3) fixed relative to the housing (2).
